(19) United States
(12) Patent Application Publication
(10) Pub. No.: US 2015/0346018 A1
(43) Pub. Date: Dec. 3, 2015

(54) AN APPARATUS FOR NON-CONTACT LEVEL SENSING

(71) Applicant: PRICOL LIMITED, Coimbatore, Tamil (IN)

(72) Inventor: MANIVANNAN M, Coimbatore (IN)

(73) Assignee: PRICOL LIMITED, Coimbatore (IN)

(21) Appl. No.: 14/763,307

(22) PCT Filed: Jan. 24, 2014
(86) PCT No.: PCT/IN2014/000058

§ 371 Date: Jul. 24, 2015

(30) Foreign Application Priority Data
Jan. 24, 2013 (IN) 5384/CHE/2012

(51) Int. Cl. G01F 23/38; G01D 5/20

(52) U.S. Cl. CPC G01F 23/38; G01D 5/2013

(57) ABSTRACT

Provided is a sensing device used for sensing the level of the liquid in a liquid storage system. The sensing device according to the invention is a non contact type and uses a float comprising a sensing device and a magnet. According to the level of liquid, the float assembly moves upwards or downwards and creates variation in air gap between the sensing element and a ferromagnetic member thereby obtaining output variations which is used to update the level of the fluid in the liquid storage from time to time.

### FIELD OF INVENTION

The present invention relates to a non-contact level sensing used for detecting the level of the liquids, slurries and the like present in a container. More particularly, the present invention relates to a non-contact level sensing by using magnetic sensor, which can be used in automobiles, industrial and consumer applications. Further, the present invention relates to non-contact level sensing using a free float or an integrated float.

### BACKGROUND ART

For any tank to indicate its level of the substance present, an instrument namely level indicating gauge is used. For example in automobiles, fuel level indicating gauge is used. The fuel gauge comprises two main parts namely the sensing unit and the indicator. The sensing unit helps in sensing the level of the fuel in the tank and transmitting the information to the indicator, which helps in indicating the level of the fuel with the aid of the display unit. Therefore, sensing unit plays a vital role of measuring the level of the fuel in the tank.

The sensing unit usually uses a float connected to a potentiometer in an automobile. As the tank empties, the float drops and slides a moving contact along the resistor, increasing its resistance. When the resistance is at a certain lower point, it will also turn on a “low fuel” light in display unit of the fuel gauge system. Henceforth, the indicator unit measures and displays the amount of electrical current flowing through the sending unit. For example, when the tank level is high and maximum current is flowing, the needle points to “F” indicating a full tank. When the tank is empty and the least current is flowing, the needle points to “E” indicating an empty tank.

But if an electrical fault opens, the electrical circuit causes the indicator to show the tank as being empty and which will provoke the driver to refill the tank. Likewise, wrong indication would allow the driver to run out of fuel with no prior notification. Corrosion or wear of the potentiometer will provide erroneous readings of fuel level. An electric current is sent through the variable resistor to which a float is connected, so that the value of resistance depends on the fuel level. In most of automotive fuel gauges, such resistors are on the inward side of gauge i.e. inside fuel tank. Sending current through such a resistor has fire hazard associated with it. These resistance sensors are also showing an increased failure rate with the incremental additions of alcohol in automotive gasoline fuel. Alcohol increases the corrosion rate at the potentiometer, as it is capable of carrying current like water. Potentiometer applications for alcohol fuel use a pulse and hold methodology in that a periodic signal is sent to determine fuel level decreasing the corrosion potential.

Although these sensors have been well known already for a long time and within which still ongoing developments are done in the sensor systems of the sensing unit. But, even these kinds of sensor possess demerits of occupying more space, heavy weight, expensive and even low durability.

Some of the prior arts are as follows:

U.S. Pat. No. 3,709,038 discloses a non contact type fuel gauge utilizing magnetic coupling to rotate a follower magnet having a wiper arm attached thereto for sequentially engaging a plurality of circularly spaced electrical contacts. The contacts are connected to fuel level indicator lights positioned, for example, on a snowmobile instrument panel. The drive magnet is attached to a helical element rotatable by the vertical movement of a float assembly in engagement therewith.

WO2005057138 describes a non contact type fuel level sensor for sensing the level of remaining fluid in a, container such as a fuel tank for a motorized in which fuel level sensor incorporates a magnetic sensor and magnetic circuit in a rotational sensor configuration for determining the angular position of a hub relative to its pivot base, where the hub is attached to a float-arm member. The magnetic flux sensor positioned between two movable magnets, and critical electronic components are hermetically sealed making the fuel level sensor fully submersible in fuel.

EP1450142 describes a liquid level sensor of non contact type includes a housing, a float attached to a rotary shaft which is rotatably provided in the housing, a magnet which is fixed to the rotary shaft, and rotating together with the rotary shaft, a pair of stators which are disposed so as to face an outer peripheral surface of the magnet, and an electronic circuit which includes at least a set of terminals and a magneto electric transuding element for detecting a change of magnetic flux in the stators caused by rotation of the magnet and for outputting an electric signal. The magneto electric transuding element and the stators are electrically connected and fixed to the set of terminals so that a terminal assembly is formed. The housing is formed by insert molding the terminal assembly with resin so that the terminal assembly is embedded in the housing

EP1437580 relates to a non contact liquid level sensing system in a tank includes a sensor part provided to the tank and for sensing a position of the liquid level in accordance with displacement of a float, and a sensor casing arranged in the tank to be isolated from liquid and for accommodating the sensor part.

Therefore, there is demand for another safer, non-contact method for fuel level sensing. It is desirable to provide an apparatus for non-contact level sensing which is useful not only to the fuel but also for any other liquid present in a tank, which will avoid the problems/disadvantages, noted above and overcome other problems encountered in conventional methods.

### OBJECTS OF INVENTION

One or more of the problems of the conventional prior art may be overcome by various embodiments of the present invention.

It is the primary object of the present invention to provide an apparatus for non-contact level type using magnetic sensor for sensing the level of the liquid present in a tank.

It is another object of the present invention, wherein according to the level of liquid, moveable arm and float forming a float assembly is capable of moving upward or downward, which leads to the swinging of the moveable arm with respect to pivot axis. The swinging of the moveable arm incorporates rotary motion to holder bearing the angular ferromagnetic material with respect to the pivot axis. The rotary motion of the angular ferromagnetic material provides variation in air gap between sensing element in the housing and ferromagnetic material. The sensing element provides variable output according to the air gap sensed.

It is another object of the present invention, wherein the float is capable of moving upward or downward direction according to the level of liquid, which causes the swinging of the ferromagnetic moveable arm with respect to the pivot axis. The swinging action of the ferromagnetic moveable arm provides variation in air gap between the sensing element and ferromagnetic moveable arm. The sensing element provides variable output according to the air gap sensed.

It is another object of the present invention, wherein an arm made of ferromagnetic material which is pivoted about a pivot axis and held by spring force and a cylindrical float housed within a container, wherein the arm and the cylindrical float capable of moving upward or downward in between the walls of a container and arm which leads to the oscillation of the arm with respect to the pivot axis. The oscillation of the arm provides variation in air gap between the sensing element in the flange and vertical portion of the ferromagnetic moveable arm with angled end. The sensing element provides variable output according to the air gap sensed.

It is another object of the present invention, wherein the output variations can be discrete or linear based on the ferromagnetic material design.

It is another object of the present invention to provide an apparatus for non-contact level sensing with a contact-less principle, which will not prone to wear.

It is yet another object of the present invention to provide an apparatus for non-contact level sensing which can be used in high temperature application.

It is further yet another object of the present invention to provide an apparatus for non-contact level sensing for automobiles, industrial and consumer applications.

### SUMMARY OF INVENTION

Accordingly there is provided an apparatus for non-contact level sensing of liquid in a tank comprising of:

a sensing element and a magnet mounted on a printed circuit board;
a float arm having a first end and a second end;
a holder;
a ferromagnetic disc having an angular face; and
a float,
wherein the sensing element is fixed to back side of the magnet,
wherein the ferromagnetic disc is coaxially mounted on the holder such that the angular face is remote from the ferromagnetic disc and fitted to the first end of the float arm,
wherein the first end of the float arm is rotatably supported about the first axis,
wherein the float is connected to the second end of the float arm at a second axis, and
wherein movement of the float about the second axis causes rotation of the first end of the float arm about the first axis resulting in change in distance between the face of the sensing element and the angular face of the ferromagnetic disc and thereby magnetic field about the sensing element changes, altering signal output from the sensing element which corresponds with amount of the liquid located within the tank.

According to another aspect of the invention, the apparatus for non-contact level sensing of liquid comprising of:

a sensing element and a magnet mounted on a printed circuit board;
a tank;
a float arm having a first end and a second end;
a pivot pin; and
a float,
wherein the sensing element is fixed to back side of the magnet and located outside the liquid tank at a pre determined location,
wherein the float arm is made of ferromagnetic material and pivoted with a pivot pin about the pivot axis,
wherein the float is connected to the second end of the float arm at a second axis,
wherein the first end of a float arm is provided with a bent portion with inclination of pre determined angle, and
wherein movement of the float about the second axis results in change in distance between the face of the sensing element and the bent portion disposed in the first end of the float arm and thereby magnetic field about the sensing element changes, altering signal output from the sensing element, which corresponds with amount of the liquid located within the tank.

According to another aspect of the invention, the apparatus for non-contact level sensing of liquid comprising of:

a sensing element and a magnet mounted on a printed circuit board;
a tank;
a container comprising one or more vertical walls and a bottom wall with an opening;
an arm made of ferromagnetic material; and
a cylindrical float,
wherein the sensing element is fixed to back side of the magnet and located outside liquid tank at a pre determined location,
wherein one end of the arm is pivoted with a pivot pin about the pivot axis,
wherein the container comprising the arm and the ball is fixed inside the tank at a pre determined location such that the non pivoted end of the arm is located at distance from the face of the sensing element;
wherein the cylindrical float is held by force exerted by a spring and slide freely between the vertical walls of the container and the arm and
wherein upward/downward movement of the cylindrical float swings the arm with respect to the pivot axis resulting in change in the distance between the face of the sensing element and the non pivoted end of the arm and thereby magnetic field about the sensing element changes, altering signal output from the sensing element, which corresponds with amount of the liquid located within the tank.

According to another aspect of the invention the sensing element is magnetic resistive sensor or Hall effect sensor.

According to another aspect of the invention the sensing element is provided with one or more terminals for connecting wires which are provided for interfacing with an electrical circuit to determine the level of the liquid.

According to another aspect of the invention the magnetic disc is in the shape of an annular ring having an inner diameter and an outer diameter defining a thickness portion in between them.

According to another aspect of the invention the output variations can be discrete or linear.

### BRIEF DESCRIPTION OF THE DRAWINGS

FIG. 1: Schematically illustrates the cross sectional front view of the apparatus for non-contact level sensing according to the first embodiment of the present invention corresponding to the minimum liquid level in the tank.

FIG. 2: Schematically illustrates the cross sectional front view of the apparatus for non-contact level sensing according to the first embodiment of the present invention corresponding to the maximum liquid level in the tank.

FIG. 3: Schematically illustrates the cross sectional front view of the apparatus for non-contact level sensing according to the second embodiment of the present invention corresponding to the minimum liquid level in the tank.

FIG. 4: Schematically illustrates the cross sectional front view of the apparatus for non-contact level sensing according to the second embodiment of the present invention corresponding to the maximum liquid level in the tank.

FIG. 5: Schematically illustrates the cross sectional front view of the apparatus for non-contact level sensing according to the third embodiment of the present invention corresponding to the minimum liquid level in the tank.

FIG. 6: Schematically illustrates the cross sectional front view of the apparatus for non-contact level sensing according to the third embodiment of the present invention corresponding to the maximum liquid level in the tank.

FIG. 7: illustrates the graphical representation of output variations with different positions of sensing element according to the present invention.

### DETAILED DESCRIPTION OF THE INVENTION WITH REFERENCE TO THE ACCOMPANYING FIGURES

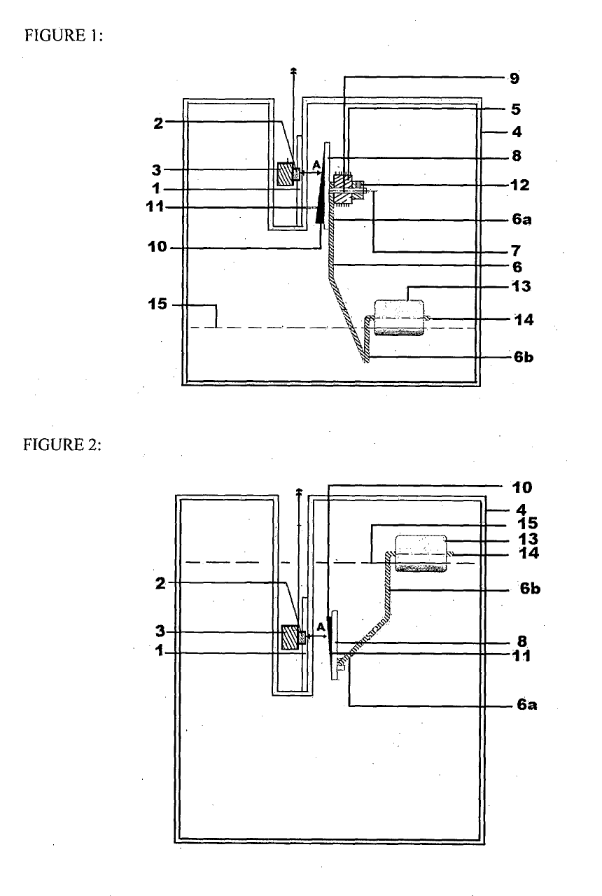

FIGS. 1 and 2 illustrate one of the non-limiting example of a liquid level sensing arrangement according to the present invention. The liquid level sensing arrangement configured to be installed in a liquid tank, for example vehicle fuel tank.

The apparatus according to the invention comprises a sensing element (2) and a magnet 3. The sensing element (2) and the magnet (3) are mounted on a printed circuit board (1) and fitted outside of the tank (4) at a pre determined location such that the sensing element is free from contact with the liquid whose level being sensed. The sensing element may be selected from magnetic resistive sensor, Hall effect sensor. The magnet (3) is fixed to back side of the sensing element (2) and the sensing element (2) is provided with one or more terminals for connecting the wires which are provided for interfacing with the electrical circuit to determine the level of the liquid from time to time.

A bearing (5) provided with a cylindrical passage opening is fitted inside the liquid tank (4) at a pre determined location. The bearing (5) may be constructed of a material capable of withstanding exposure to liquid preferably constructed of a non-magnetic material.

The apparatus, according to the invention may further include a float arm (6) having a first end (6a) and a second end (6b). The first end (6a) is disposed for rotation about a first axis (7). The float arm (6) may be constructed of a material capable of withstanding exposure to the liquid filled in the tank (4) and provide sufficient rigidity.

The first end (6a) of the float arm (6) is having a passage opening and rigidly fitted to a holder (8). The holder (8) which is circular in shape is provided with a concentrically arranged hub portion (9) and disposed to accommodate a ferromagnetic disc (10).

One of the faces of the ferromagnetic disc (10) is angular in shape. The ferromagnetic disc (10) is coaxially mounted on the holder (8) such that the angular face (11) is remote from the holder (8). The hub portion (9) of the holder (8) passes through the passage opening provided in the first end (6a) of the float arm (6) and rotatably supported about the first axis (7) in the bearing (5) and retained in position by a locking screw provided in the setting ring (12)

In one of the embodiments, the ferromagnetic disc (10) is in the shape of an annular ring having an inner diameter and an outer diameter defining a thickness portion in between them which is larger than the face of the sensing element.

On assembly, the float arm (6) comprising the holder (8) fitted with the ferromagnetic disc (10) defines a distance (A) between the face of the sensing element (2) and the angular face (11) ferromagnetic disc (10).

The apparatus according to the invention further include a float (13) which is connected to the second end (6b) of the float arm (6) at a second axis (14). The float (13) is constructed of a material that is buoyant in the liquid present in the tank (4). Movement of the float (13) about the second axis (14) causes rotation of the first end (6a) of the float arm (6) about the first axis (7).

When the liquid level (15) in the tank (4) changes, the float (13) changes its position, thus moving the float arm (6) and which in turn rotating ferromagnetic disc (10) about the first axis (7). As the ferromagnetic disc (10) rotates/swings around the first axis (7), the distance (A) between the face of the sensing element (2) and the angular face of (11) ferromagnetic disc (10) changes. Thus, the magnetic field about the sensing element (2) changes, altering the signal output from the sensing element (2), which corresponds with the amount of liquid located within the tank (4). The output variations can be discrete or linear based on the ferromagnetic disc (10) design.

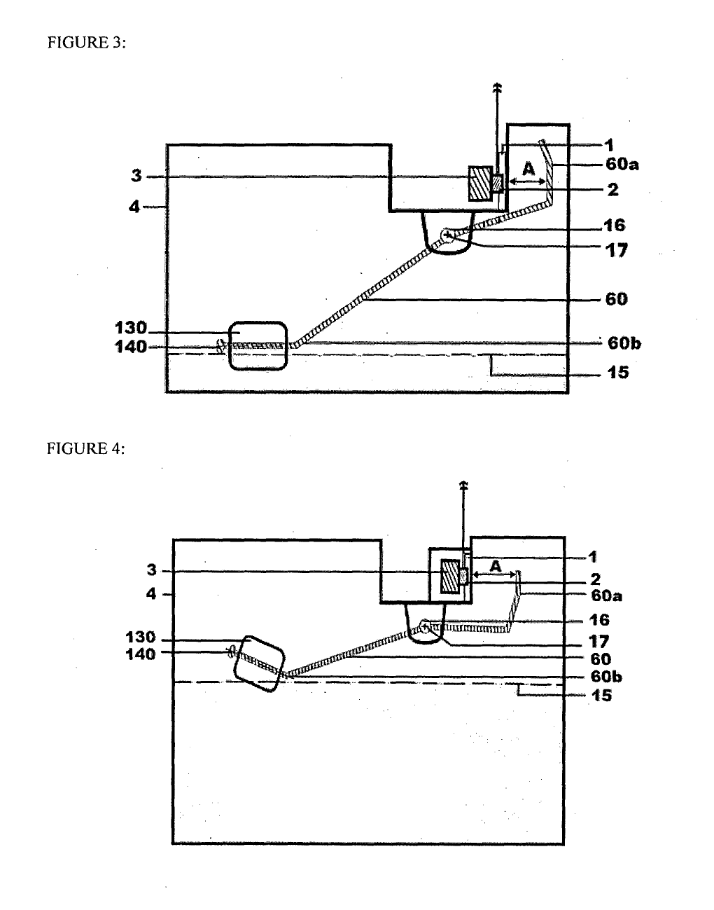

FIGS. 3 and 4 illustrate another example of a liquid level sensing arrangement according to the present invention. The apparatus comprises a float arm (60) having a first end (60a) and a second end (60b). The float arm (60) is made of ferromagnetic material and its first end (60a) is provided with a bent portion with an inclination of pre determined angle. The sensing element (2) and the magnet (3) are mounted on a printed circuit board (1) and is fitted outside of the tank (4) at a pre determined location such that the sensing element is free from contact with the liquid whose level being sensed. The printed circuit board (1) comprising the sensing element (2) and the magnet (3) is positioned such that it can sense the distance (A) from the face of the sensing element (2) and the inclined portion disposed in the first end (60a) of the float arm (60). The float arm (60) is pivoted with a pivot pin (16) about the pivot axis (17). The float (130) is connected to the second end (60b) of the float arm (60) at a second axis (140).

When the liquid level (15) of the tank (4) changes, the float (130) changes position, thus moving the float arm (60) and in turn the distance (A) between the face of the sensing element (2) and the bent portion disposed in the first end (60a) of the float arm (60) changes. Thus, the magnetic field about the sensing element (2) changes, altering the signal output from the sensing element (2), which corresponds with the amount of liquid located within the tank (4). The output variations can be discrete or linear based on the float arm (60) design.

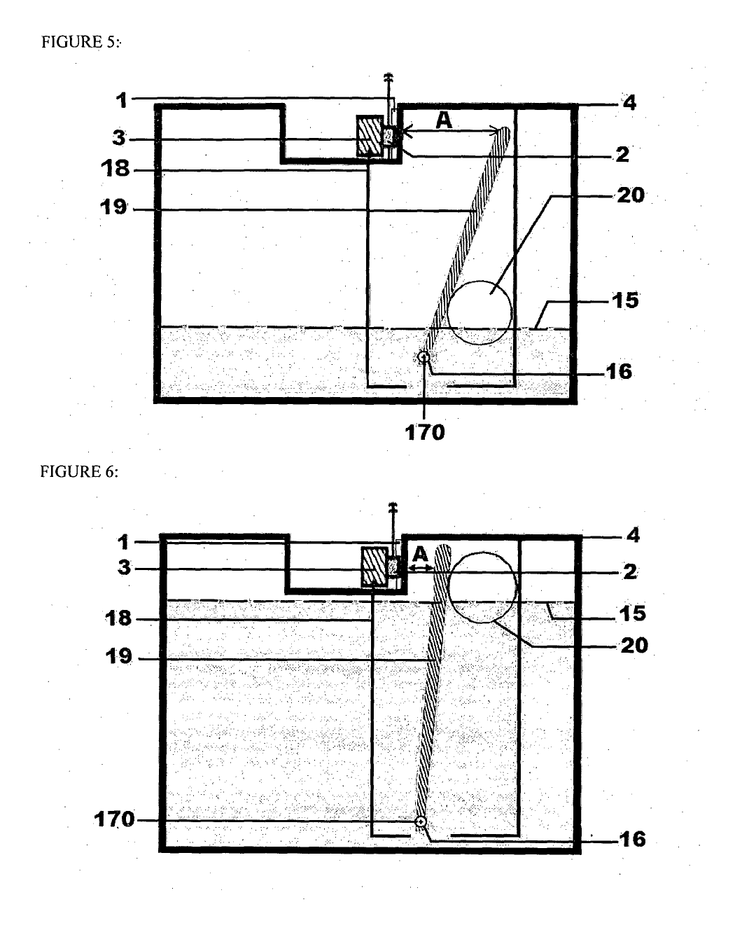

FIGS. 5 and 6 illustrate yet another example of a liquid level sensing arrangement according to the present invention. The sensing element (2) and the magnet (3) are mounted on a printed circuit board (1) and is fitted outside of the tank (4) at a pre determined location such that the sensing element is free from contact with the liquid whose level being sensed. A container (18) in the form of a box with open top comprising one or more vertical walls and a bottom wall with opening for the liquid entry and is disposed for accommodating an arm (19) made of ferromagnetic material and a cylindrical float (20): One end of the arm (19) is pivoted in the container with pivot pin (16) at a pivot axis (170). The container (18) is fixed inside the tank (4) at a pre determined location such that non pivoted end of the arm (19) is at distance (A) from the face of the sensing element (2). The container (18) may be constructed of a material capable of withstanding exposure to the liquid filled in the tank (4) and provide sufficient rigidity.

The cylindrical float (20) is constructed of a material that is buoyant in the liquid present in the tank (4) and is held between the vertical walls of the container (18) and the arm (19) by the force exerted by a spring, which may be for example a torsion spring fitted at the pivot axis (170). The spring exerts a force which is just enough to push the arm (19) towards the cylindrical float (20) at the same time permit the free movement of the cylindrical float (20) up and down according to the liquid level and slide freely in the space between the arm (19) and the vertical walls of the container (18). The movement of the cylindrical float (20) swings the arm (19) with respect to the pivot axis (170).

When the liquid level (15) of the tank (4) changes, the cylindrical float (20) move upward/down ward thus swinging the arm (19) with respect to the pivot axis (170) and in turn the distance (A) between the face of the sensing element (2) and the non pivoted end of the arm (19) changes. Thus, the magnetic field about the sensing element (2) changes, altering the signal output from the sensing element (2), which corresponds with the amount of liquid located within the tank (4). The output variations can be discrete or linear based on the arm (19) design.

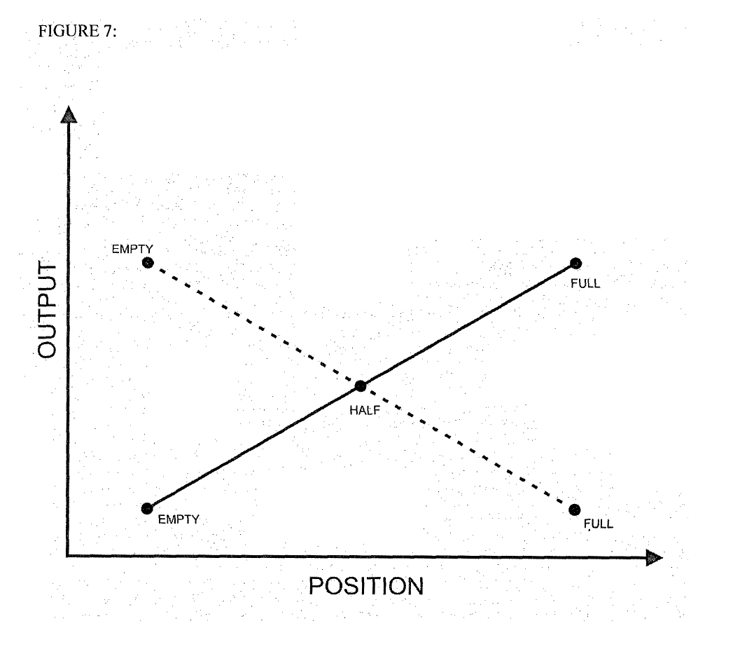

FIG. 7 illustrates the graphical representation of output variations with different positions of sensing element according to the present invention, wherein the continuous line represents the increasing output values and the broken line represents the decreasing output values.

1. An apparatus for non-contact level sensing of liquid in a tank comprising of:
a sensing element and a magnet mounted on a printed circuit board;
a float arm having a first end and a second end;
a holder;
a ferromagnetic disc having an angular face; and
a float,
wherein the sensing element is fixed to back side of the magnet and located outside the tank at a pre determined location,
wherein the ferromagnetic disc is coaxially mounted on the holder such that the angular face is remote from the holder and said holder is fitted to the first end of the float arm,
wherein the first end of the float arm is rotatably supported about the first axis,
wherein the float is connected to the second end of the float arm at the second axis,
wherein movement of the float about the second axis causes rotation of the first end of the float arm about the first axis resulting in change in distance (A) between face of the sensing element and the angular face of the ferromagnetic disc and thereby magnetic field about the sensing element changes, altering signal output from the sensing element, which corresponds with amount of the liquid located within the tank, and
wherein the sensing element provides variable output according to the distance (A) sensed.

2. An apparatus for non-contact level sensing of liquid comprising of:
a sensing element and a magnet mounted on a printed circuit board;
a tank;
a float arm having a first end and a second end;
a pivot pin; and
a float,
wherein the sensing element is fixed to back side of the magnet and located outside the tank at a pre determined location,
wherein the float arm is made of ferromagnetic material and pivoted with a pivot pin about the pivot axis,
wherein the float is connected to the second end of the float arm at the second axis,
wherein the first end of the float arm is provided with a bent portion with inclination of pre determined angle,
wherein the printed circuit board senses distance (A) from face of the sensing element and the inclined portion disposed in the first end of the float arm,
wherein movement of the float about the second axis results in change in the distance (A) between the face of the sensing element and the bent portion disposed in the first end of the float arm and thereby magnetic field about the sensing element changes, altering signal output from the sensing element, which corresponds with amount of the liquid located within the tank, and
wherein the sensing element provides variable output according to the distance (A) sensed.

3. An apparatus for non-contact level sensing of liquid comprising of:
a sensing element and a magnet mounted on a printed circuit board;
a tank;
a container comprising one or more vertical walls and a bottom wall with an opening;
an arm made of ferromagnetic material; and
a cylindrical float,
wherein the sensing element is fixed to back side of the magnet and located outside tank at a pre determined location,
wherein one end of the arm is pivoted with a pivot pin about a pivot axis,
wherein the container comprising the arm and the cylindrical float is fixed inside the tank at a pre determined location such that the non pivoted end of the arm is located at distance (A) from face of the sensing element,
wherein the cylindrical float is held by force exerted by a spring and slide freely between the vertical walls of the container and the arm,
wherein upward/downward movement of the cylindrical float swings the arm with respect to the pivot axis resulting in change in the distance (A)/between the face of the sensing element and the non pivoted end of the arm and thereby magnetic field about the sensing element changes, altering signal output from the sensing element, which corresponds with amount of the liquid located within the tank, and
wherein the sensing element provides variable output according to the distance (A) sensed.

4. The apparatus according to claim 1, wherein the sensing element is magnetic resistive sensor or Hall Effect sensor.

5. The apparatus according to claim 4, wherein the sensing element is provided with one or more terminals for connecting wires which are provided for interfacing with an electrical circuit to determine the level of the liquid.

6. The apparatus according to claim 1, wherein the ferromagnetic disc is in the shape of an annular ring having an inner diameter and an outer diameter defining a thickness portion in between them.

7. The apparatus according to claim 1, wherein output variations of the sensing element can be discrete or linear based on the ferromagnetic material design.

8. The apparatus according to claim 2, wherein the sensing element is magnetic resistive sensor or Hall Effect sensor.

9. The apparatus according to claim 8, wherein the sensing element is provided with one or more terminals for connecting wires which are provided for interfacing with an electrical circuit to determine the level of the liquid.

10. The apparatus according to claim 2, wherein output variations of the sensing element can be discrete or linear based on the ferromagnetic material design.

11. The apparatus according to claim 3, wherein the sensing element is magnetic resistive sensor or Hall Effect sensor.

12. The apparatus according to claim 11, wherein the sensing element is provided with one or more terminals for connecting wires which are provided for interfacing with an electrical circuit to determine the level of the liquid.

13. The apparatus according to claim 3, wherein output variations of the sensing element can be discrete or linear based on the ferromagnetic material design.
